(19) United States
(12) Patent Application Publication
(10) Pub. No.: US 2021/0375127 A1
(43) Pub. Date: Dec. 2, 2021

(54) System and Method for Distribution-Based Traffic Control

(71) Applicant: Mitsubishi Electric Research Laboratories, Inc., Cambridge, MA (US)

(72) Inventors: Uros Kalabic, Jamaica Plain, MA (US); Piyush Grover, Lincoln, NE (US); Schuchin Aeron, Newton, MA (US)

(21) Appl. No.: 16/889,224

(22) Filed: Jun. 1, 2020

(51) Int. Cl. G08G 1/01; G05D 1/00

(52) U.S. Cl. CPC G08G 1/0145; G05D 2201/0213; G05D 1/0088

(57) ABSTRACT

Embodiments disclose a system for traffic control. The system comprises a receiver configured to receive traffic information indicative of a state of a traffic; a processor configured to determine one or more control commands to control at least a subset of vehicles forming the state of the traffic by minimizing a multiscale normalization of a difference between a flow of one or more vehicles of the subset of vehicles forming the traffic and a uniform flow of the one or more vehicles; and a transmitter configured to transmit the one or more control commands to the subset of vehicles.

### TECHNICAL FIELD

This invention relates to controlling movement of vehicles and more particularly to system and method for controlling traffic of vehicles.

### BACKGROUND

It is generally understood that traffic congestion is an issue with significant negative consequences to society and the environment. Conventionally, traffic congestion has been improved by manipulating time for traffic light indication. In some other cases, roads are constructed or removed to ease traffic congestion. With the advent of wireless technology and connected components, it has become possible to communicate with vehicles and road infrastructure to make real-time decisions for improving traffic. For example, use of smartphones in vehicles allows monitoring traffic and estimating congestion on roads. Further improvement in wireless technology provides an ability to track vehicle positions or locations in real-time at a much larger scale. It also provides an ability to communicate back to vehicles at rapid rates. If some of these vehicles are autonomous vehicles, or vehicles that may be operated autonomously, then communication bandwidth is adequate for real-time vehicle control. Therefore, with adequate wireless technology, vehicles are controlled in real-time to achieve improvement in vehicular traffic.

Generally, traffic is viewed as a distribution of vehicles along a road, where speed of traffic is dependent on the distribution of vehicles forming traffic. The distribution of vehicles includes both type of vehicles, i.e. autonomous vehicles and non-autonomous vehicles. In such a distribution, a portion of the vehicles, i.e. the autonomous vehicles, may be directly controlled to ease the traffic. When the autonomous vehicles are controlled, the non-autonomous vehicles may follow their natural driving behavior. However, such traffic control techniques based on the distribution of different vehicles may provide a sub-optimal result. As a result, traffic congestion is not removed which leads to the inconvenience of occupants and/or operators of the vehicles.

Accordingly, there is a need for a technical solution that the vehicles cooperate to provide control for improving traffic.

### SUMMARY

Various embodiments disclose a system and method for controlling traffic. It is an object of some embodiments to disclose a system and method for controlling traffic including one or combination of autonomous, semi-autonomous, and manually-operated vehicles using the autonomous vehicles. Additionally, or alternatively, it is an object of one embodiment to incentivize a subset of vehicles and control traffic. The subset of vehicles may be incentivized to flip from an uncooperative to a cooperative mode. Such cooperative vehicles are controlled via a central controller. In some embodiments, the cooperative vehicles correspond to the autonomous vehicles. To that end, a subset of vehicles is selected for controlling the traffic. Additionally, or alternatively, the selected subset of autonomous vehicles is updated periodically based on a predetermined time-period. Additionally, or alternatively, it is an object of some embodiment to provide distribution-based traffic control that aims to achieve a uniform distribution of the vehicles forming the traffic.

Some embodiments are based on a recognition that stabilizing the traffic to a uniform distribution can be based on a distance-based normalization, such as Lp normalization (i.e. L2 norm). However, the distance-based norm fails to achieve a uniform distribution in a reasonable amount of time. To that end, some embodiments employ a multiscale normalization (multiscale norm) in solving the optimization problem for stabilizing vehicle density into the uniform distribution. Typically, the multiscale norm is implemented in optimization problems for fluid mixing. The multiscale norm ensures good and uniform mixing of fluids. In a traffic scenario, the vehicles are not fluids and but rather may be considered as particles. Hence, various particles-based techniques, such as distance-based normalization are applied to control the distribution of the vehicle. However, some embodiments, are based on realization that regardless of particle or solid nature of the vehicles, the traffic of the vehicles may be treated as fluid. Such a realization allows various embodiments to use fluid-based technique to control the distribution of the vehicle. Notably, despite the difference in dynamics of the vehicle that differs from fluid-based dynamics, such a treatment may achieve better distribution and traffic management.

For example, in a traffic scenario, presence of vehicles in a road segment and absence of vehicles in the same road segment may be considered as two different fluids. One type of fluid is the fluid of vehicles or portion of a road occupied by the vehicles. Another type of fluid is fluid of no vehicles or a portion of a road not occupied by the vehicles. Some embodiments transform the rationale behind the traffic control problem into a fluid mixing problem aiming to mix these two fluids. Such a reformulation allows some embodiments to consider various mixing techniques for traffic control problem. After testing a number of different mixing techniques, some embodiments selected a technique based on a multiscale norm optimization that shows an improvement in achieving the uniform distribution. Thus, a reason behind the use of the multiscale norm in the control of the traffic is the capability of the multiscale norm to achieve the uniform distribution of vehicles better than the use of the Lp norm.

Some embodiments are based on the recognition that a vehicular environment is a highly dynamic environment. Further, some embodiments are based on the recognition that a current state of the vehicular environment may be represented by one or more parameters of the vehicle (such as positions and velocities of the vehicles) in a region under traffic control. However, the positions and velocities of vehicles do not represent the entire environment and, thus, data-driven control methods that are based on tracking positions of the control vehicles may be ineffective.

To that end, some embodiments replace state-based control of traffic with control based on a traffic flow. In general, traffic flow defines interactions between travelers (including pedestrians, cyclists, drivers, and their vehicles) and infrastructure (including highways, signage, and traffic control devices) by labeling each element and representing the element as a particle in a flow. The traffic flow may better capture the state of the traffic on the roads than just states of vehicles. Moreover, traffic flow is an aggregation of the general state of traffic. Some embodiments are based on the realization that the traffic flow is more detailed than the estimated vehicle states and the traffic flow may be accounted for different types of mobility (not limited to vehicles), such as movement of pedestrians and cyclists. Further, some embodiments are based on the realization that traffic flow is less sensitive to the accuracy of the estimation of the vehicle states and may account for uncertainties and/or a probabilistic nature of traffic sensor data.

Some embodiments are based on the realization that traffic flow provides vehicle density values of traffic that indicates the number of vehicles per unit of space. For instance, vehicle density may correspond to 50 vehicles/mile. The density values may be a useful aggregate of the state of the traffic in addition or alternatively to only the positions or even the states of vehicles. In such a manner, some embodiments replace tracking vehicles with tracking density of the traffic flow at each location at the control region.

In addition, one of the issues addressed by some embodiments is an arrangement of a control system configured for real-time traffic control. For example, some embodiments are based on the recognition that cloud control is impractical for optimal control of intersection passing and/or highway merging. Cloud control may not meet real-time constraints of the safety requirement due to the multi-hop communication delay. In addition, the cloud does not have instant information of vehicles, pedestrians and road condition to make optimal decisions. Also, vehicle on-board controllers may not have sufficient information to make an optimal decision, e.g., on-board control does not have information about object movement out of a visible range and cannot receive information from vehicles outside of a communication range.

To that end, some embodiments are based on the realization that edge devices such as roadside units (RSUs) are feasible control points to make optimal decision on real-time control of the control regions such as intersection passing or highway merging due to their unique features such as direct communication capability with vehicles, road condition knowledge and environment view via cameras and sensors. In addition, the edge devices at a control point such as the intersection or highway merging point may execute joint control decision via real-time collaboration and information sharing. To that end, some embodiments apply edge devices to realize real-time edge control.

In one example embodiment, a system for traffic control uses a set of edge computing devices. Each edge computing device is configured to control regions of traffic, such regions are called controlled regions. The control regions do not intersect, such that each section of each control region is controlled only by a single edge computing device from the set of edge computing devices. An edge computing device receives traffic information in the control region (which is controlled by the edge computing device) and receives traffic information in at least an adjacent section of a neighboring control region controlled by a neighboring edge computing device. The control region and the section of the neighboring control region form an observed region.

The edge computing device receives traffic information of the observed region. In some implementations, the traffic information received by the edge computing device includes states of the vehicles traveling within the observed region. The state of the vehicles may include one or a combination of positions of vehicles and speeds of vehicles. However, the traffic information may include more information such as the positions and velocities of pedestrians, positions of traffic signals, and one or a combination of positions and velocities of other traffic elements. Some of this additional information may be monitored and/or received by the edge computing devices, but not all of it may be monitored. Furthermore, this additional information may be further used for estimating the traffic flow including one or combination of a speed of the traffic flow, a density of the traffic flow indicating a number of vehicles per unit of space in the road map, and a current of the traffic flow indicating a number of vehicles per unit of time. For example, some embodiments determine the traffic flow from the states of the vehicles and a road map of the observed region to produce the density of the traffic flow indicating a number of vehicles per unit of space in the road map or portion of vehicle occupying a unit of space. The edge computing device determines one or more control commands to control at least a subset of vehicles forming the state of the traffic. To that end, the one or more control commands are determined by minimizing a multiscale normalization of a difference between a flow of one or more vehicles of the subset of vehicles forming the traffic and a uniform flow of the one or more vehicles.

Accordingly, one embodiment discloses a system for traffic control of vehicles. The system includes a receiver configured to receive traffic information indicative of a state of a traffic, a processor configured to determine one or more control commands to control at least a subset of vehicles forming the state of the traffic by minimizing a multiscale norm of a difference between a flow of vehicles forming the traffic and a uniform flow of the vehicles and a transmitter configured to transmit the one or more control commands to the subset of vehicles.

Another embodiment discloses a method for controlling a traffic, wherein the method uses a processor coupled with stored instructions implementing the method. The method includes receiving traffic information indicative of a state of the traffic. The method includes determining one or more control commands to control at least a subset of vehicles forming the state of the traffic by minimizing a multiscale norm of a difference between a flow of vehicles forming the traffic and a uniform flow of the vehicles. The method further includes transmitting the one or more control commands to the subset of vehicles.

Yet another embodiment discloses a non-transitory computer readable storage medium embodied thereon a program executable by a processor for performing a method, the method includes receiving traffic information indicative of a state of a traffic, determining one or more control commands to control at least a subset of vehicles forming the state of the traffic by minimizing a multiscale norm of a difference between a flow of vehicles forming the traffic and a uniform flow of the vehicles and transmitting the one or more control commands to the subset of vehicles.

### BRIEF DESCRIPTION

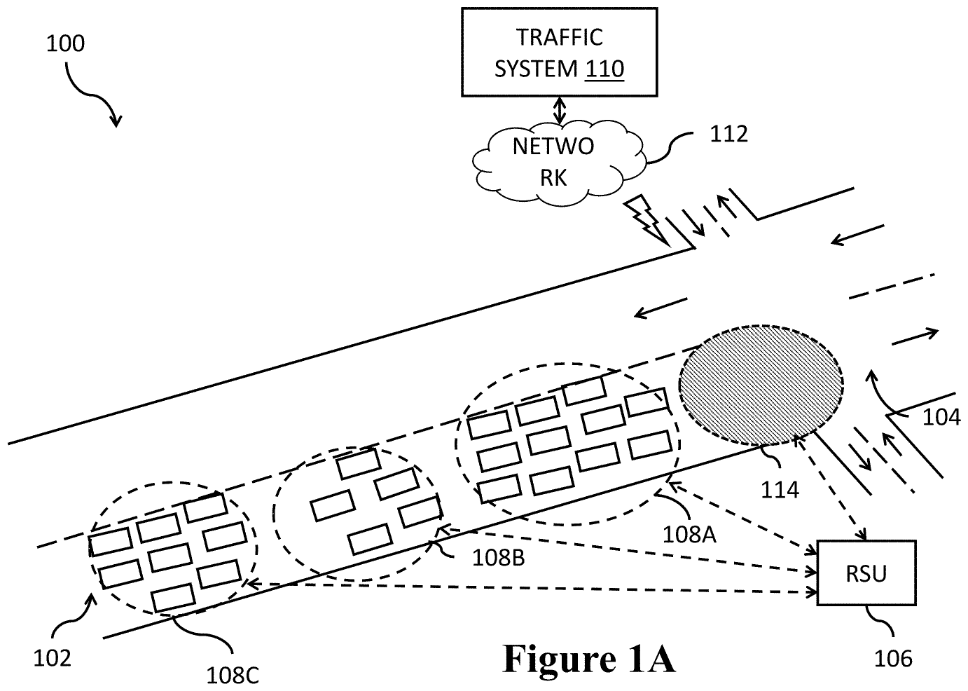

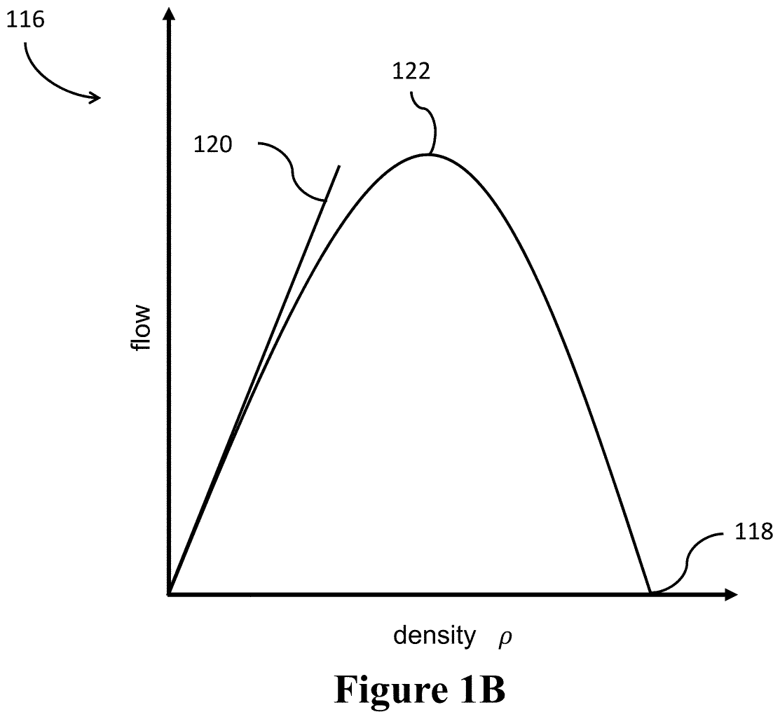

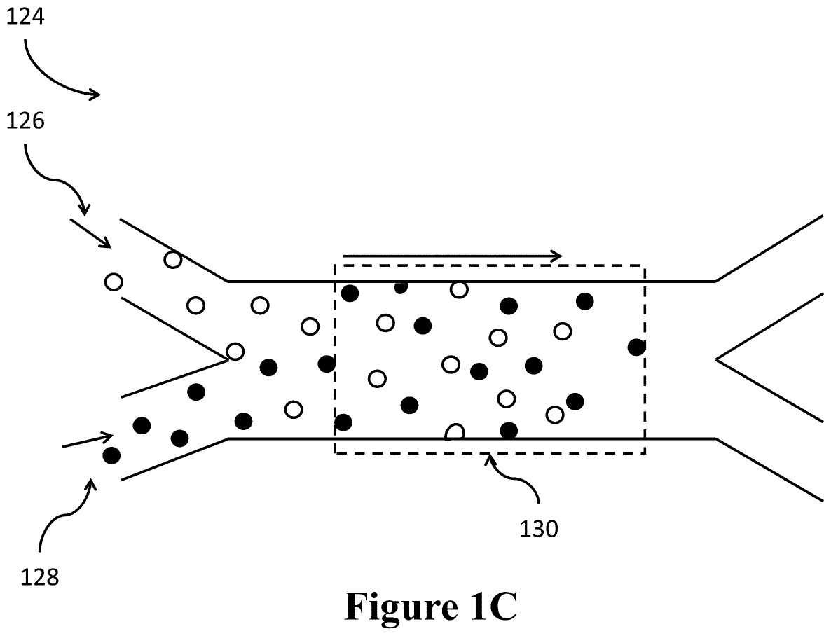

FIG. 1A illustrates an exemplar of traffic in a road segment, according to some embodiments of the present disclosure.

FIG. 1B shows a graphical plot depicting a model of the traffic in the road segment, according to some embodiments of the present disclosure.

FIG. 1C shows a schematic diagram of mixing of two fluids depicting for controlling the traffic in the road segment, according to some embodiments of the present disclosure.

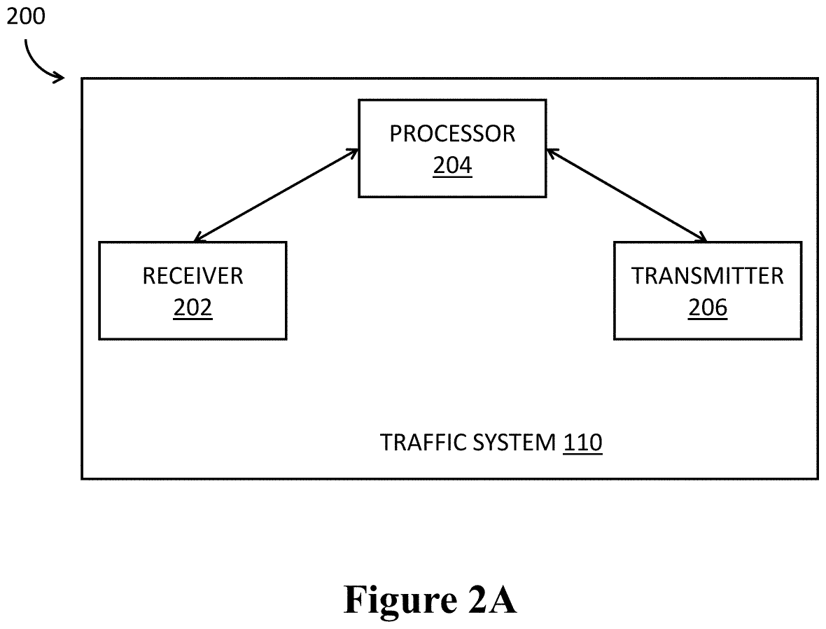

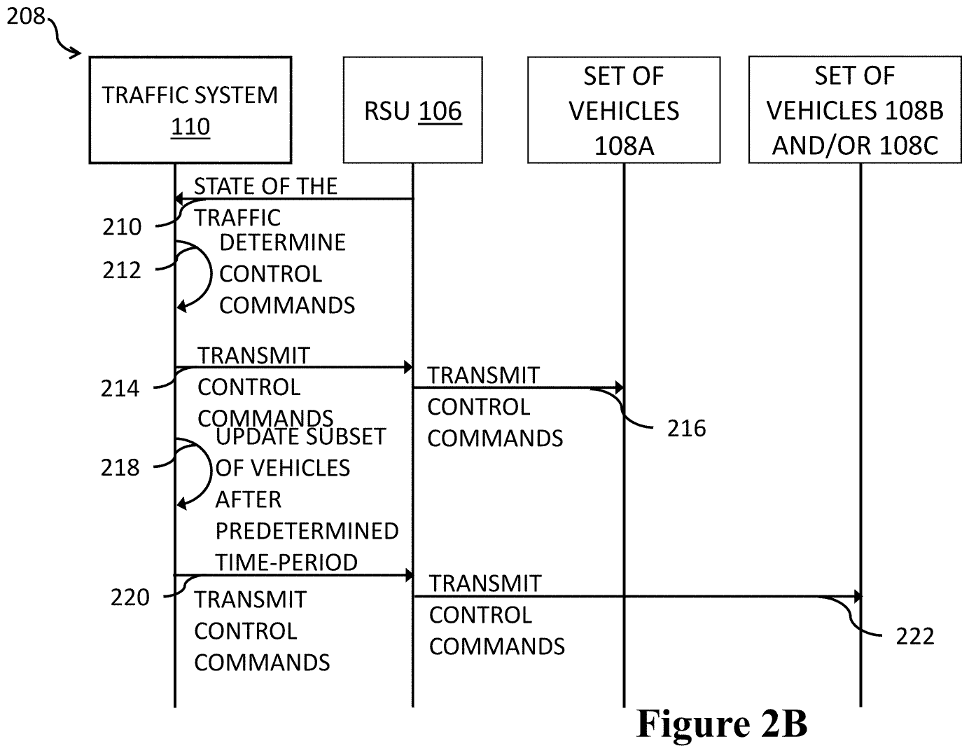

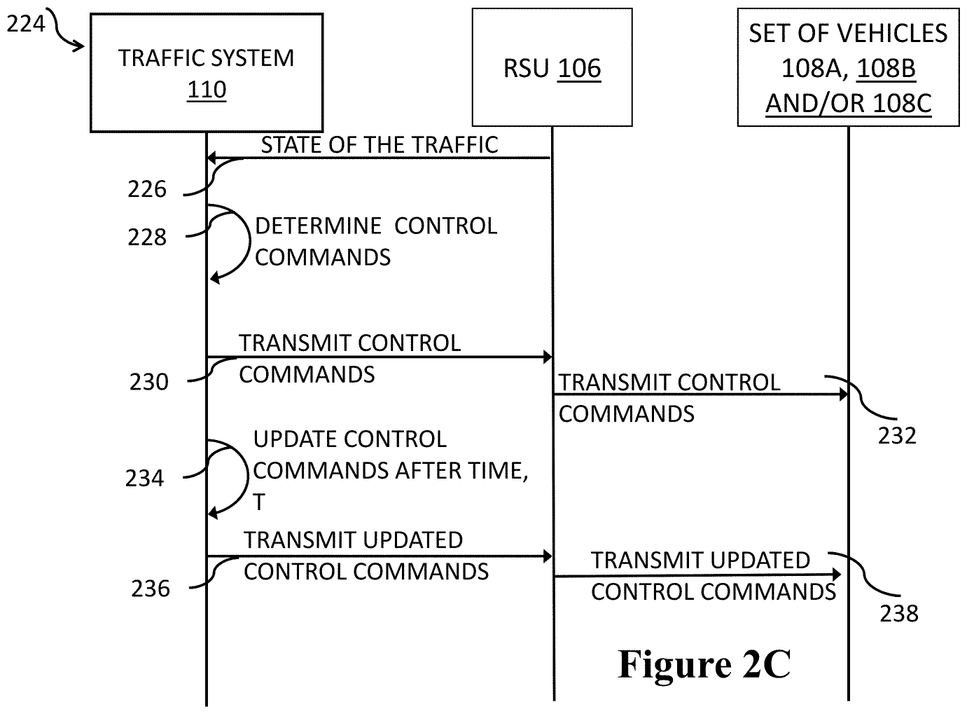

FIG. 2A shows a block diagram of the traffic system for controlling the traffic, according to some embodiments of the present disclosure.

FIG. 2B shows a sequence flow diagram of a method for controlling the traffic in the road segment by the traffic system, according to some embodiments of the present disclosure.

FIG. 2C shows a sequence flow diagram of a method for controlling the traffic in the road segment by the traffic system, according to some other embodiments of the present disclosure.

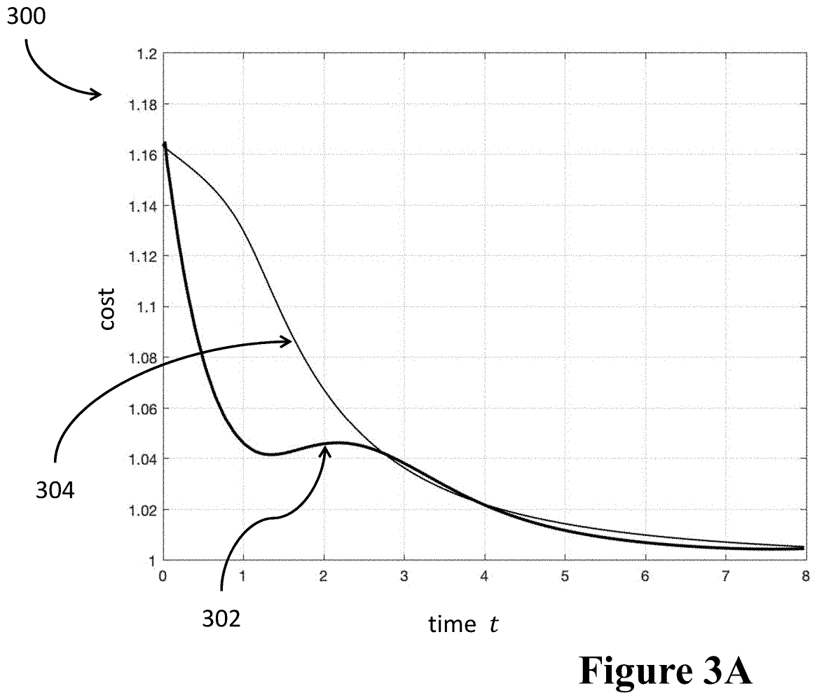

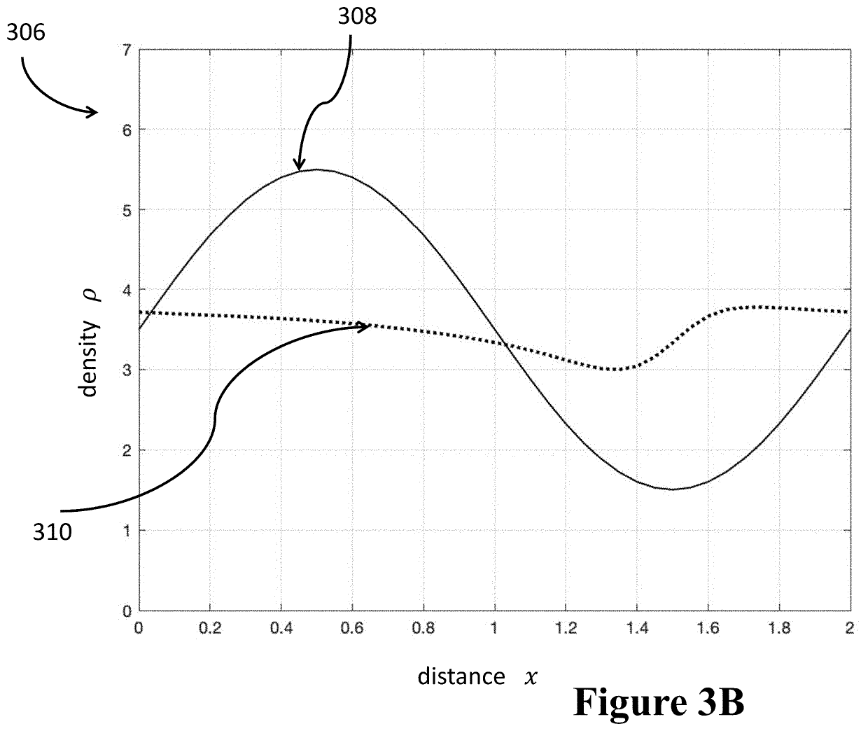

FIG. 3A shows a graphical plot depicting a cost of L2 norm on vehicle density in the traffic, according to some embodiments of the present disclosure.

FIG. 3B shows a graphical plot depicting optimization of the L2 norm, according to some embodiments of the present disclosure.

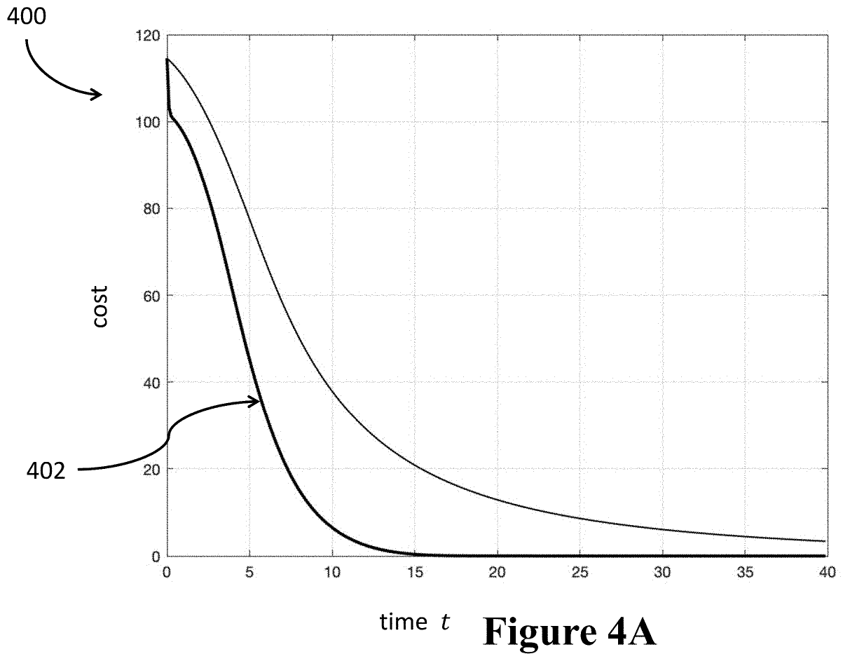

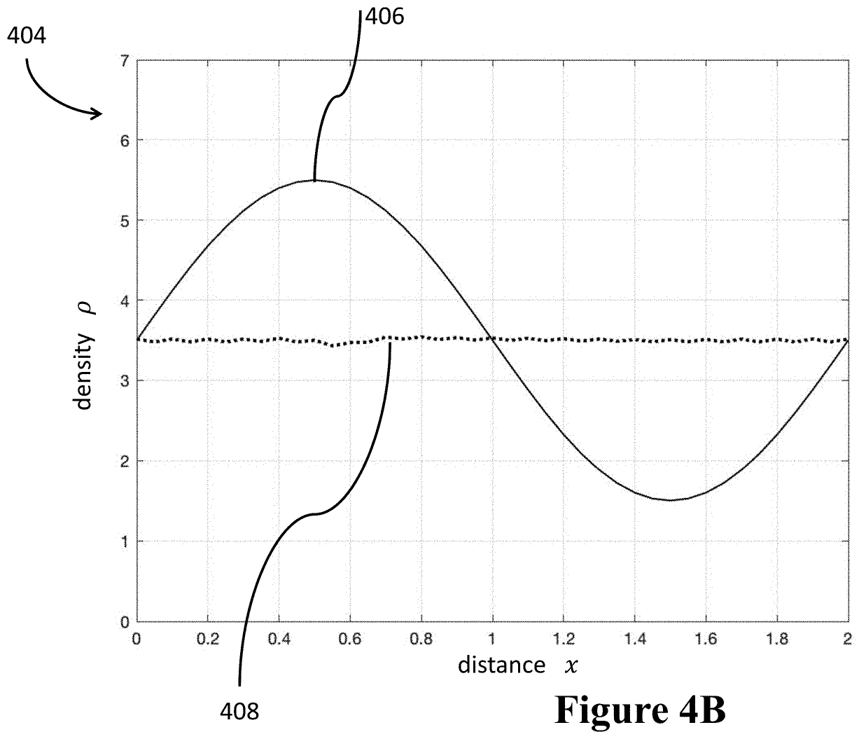

FIG. 4A shows a graphical plot depicting cost of a multiscale-norm on the vehicle density in the traffic, according to some embodiments of the present disclosure.

FIG. 4B shows a graphical plot depicting optimization of the multiscale-norm, according to some embodiments of the present disclosure.

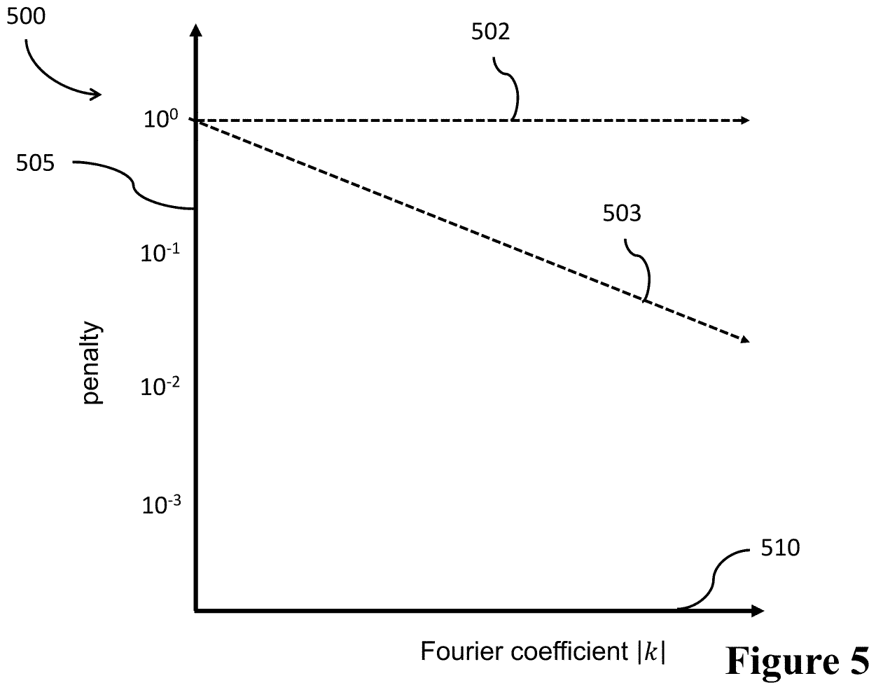

FIG. 5 shows a multiscale normalization penalizing a lower-frequency Fourier mode of the difference greater than a higher-frequency Fourier mode, according to one example embodiment of the present disclosure.

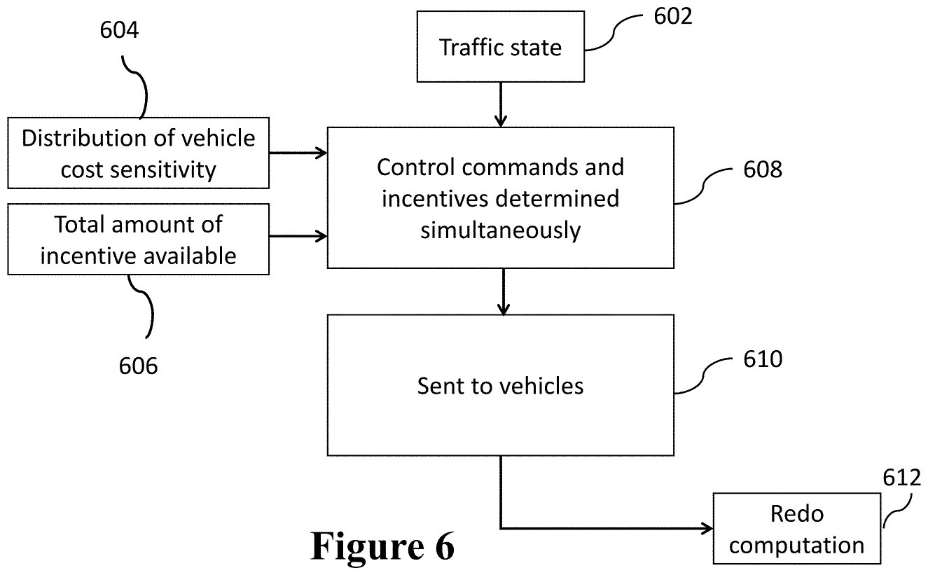

FIG. 6 shows a block diagram for determining an amount of incentive for each subset of vehicles in the road segment, according to one example embodiment of the present disclosure.

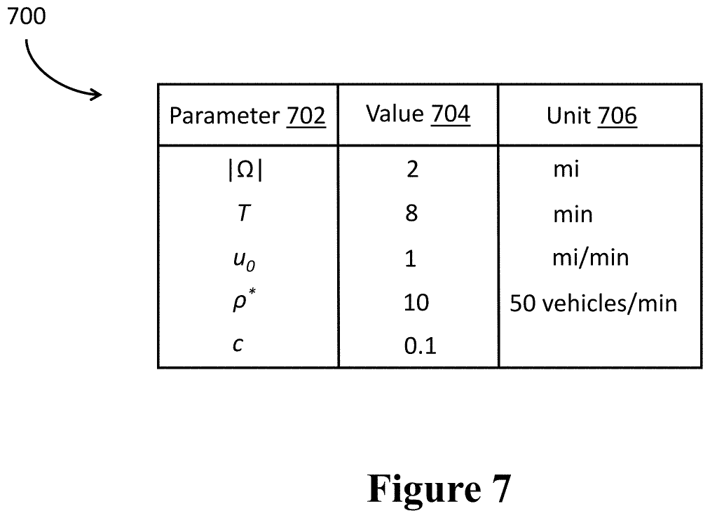

FIG. 7 shows a table of parameter for a test simulation of traffic control of a subset of vehicles, according to one example embodiment of the present disclosure.

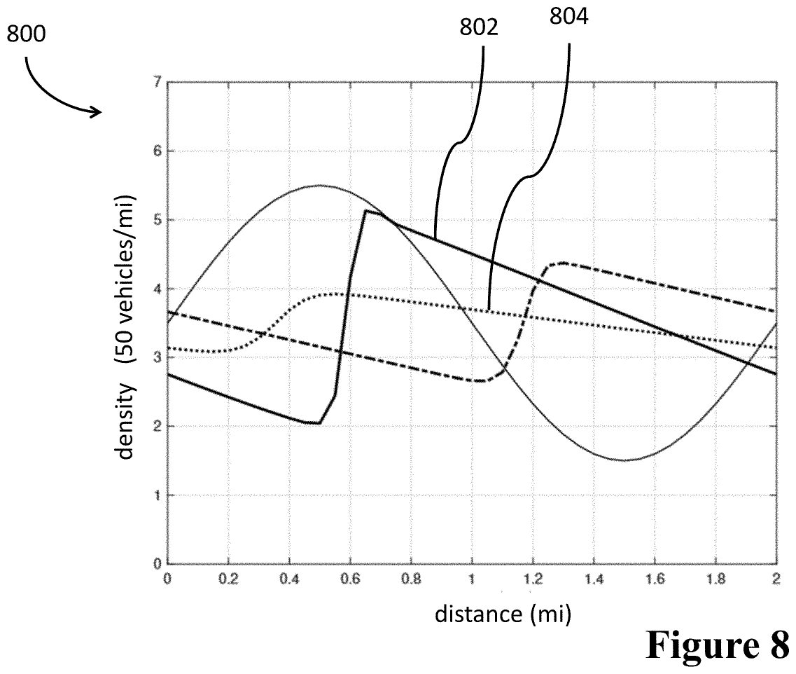

FIG. 8 shows a graphical plot depicting initial distribution of total vehicle density in the test simulation, according to one example embodiment of the present disclosure.

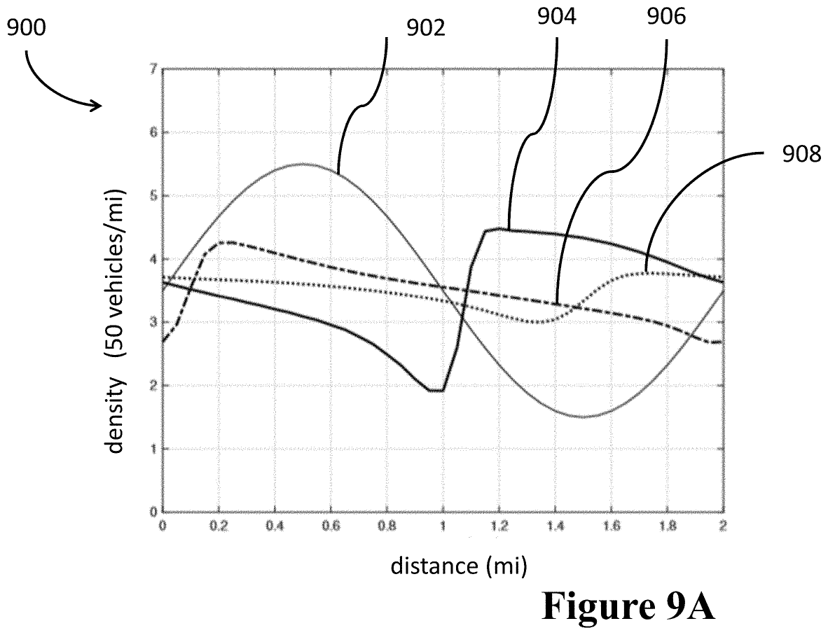

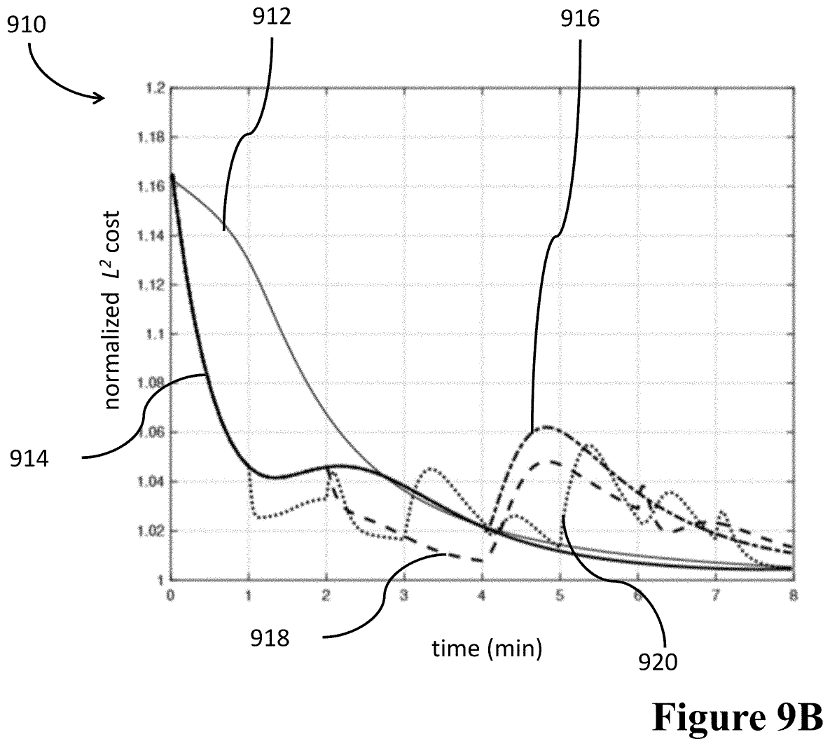

FIG. 9A shows a graphical plot depicting time history of a total vehicle density corresponding to the optimization of L2 norm cost, according to one example embodiment of the present disclosure.

FIG. 9B shows a graphical plot depicting normalized time history of the L2 norm cost corresponding to the uncontrolled vehicles, according to another example embodiment of the present disclosure.

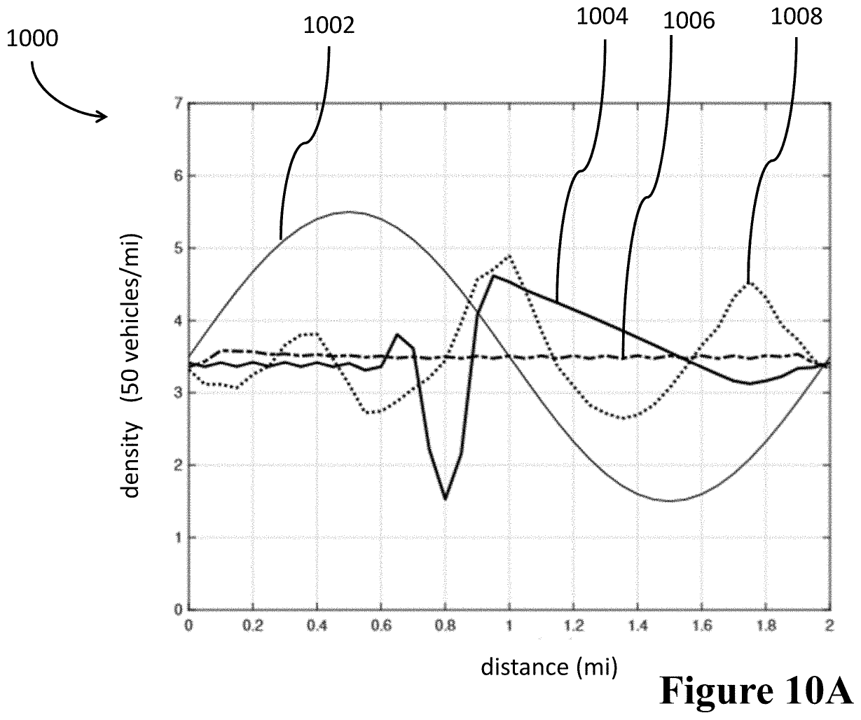

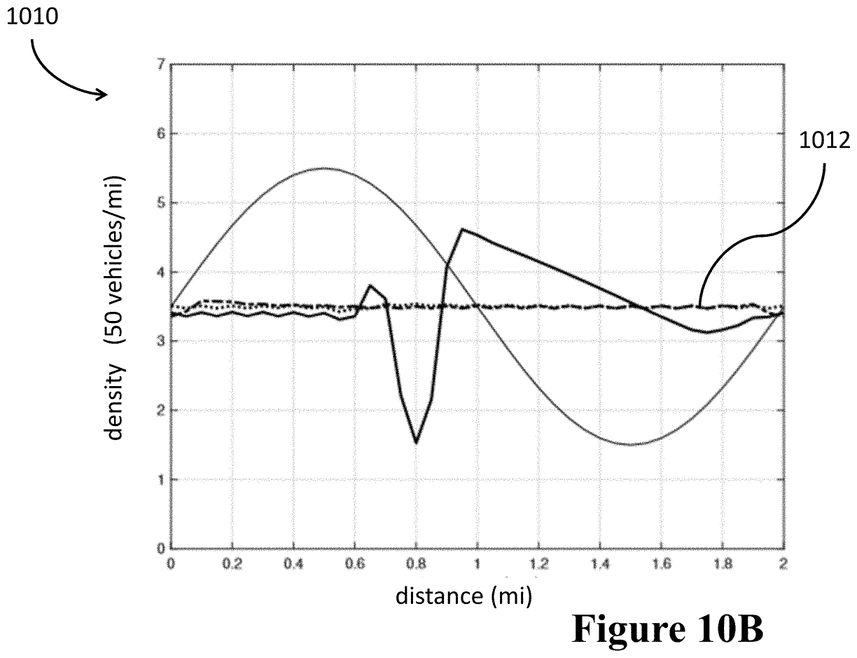

FIG. 10A shows a graphical plot depicting time history of a total vehicle density corresponding to the optimization of multiscale norm, according to one example embodiment of the present disclosure.

FIG. 10B shows a graphical plot depicting time history of total vehicle density corresponding to the optimization of multiscale norm, according to another example embodiment of the present disclosure.

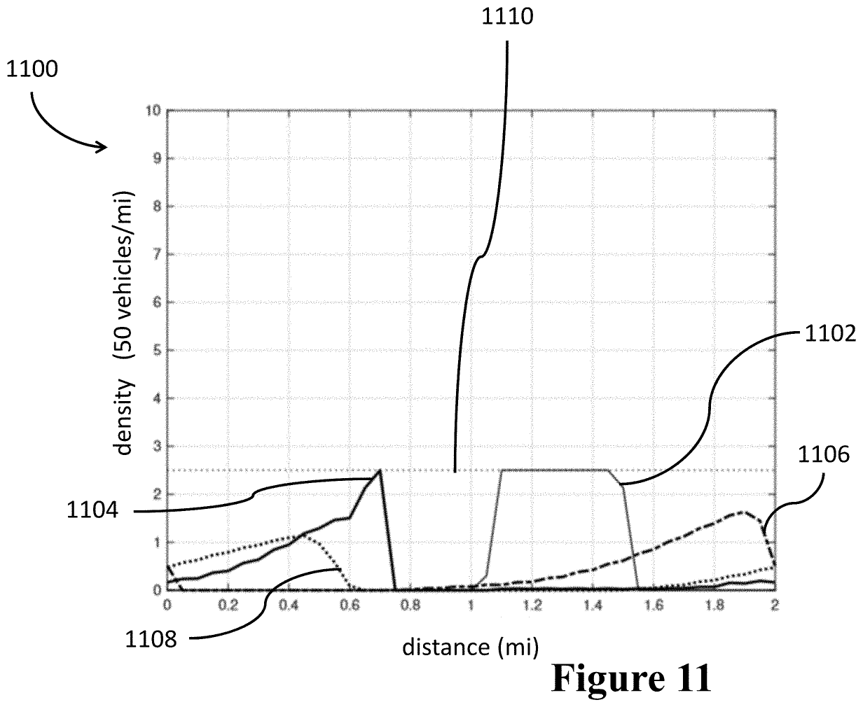

FIG. 11 shows a graphical plot depicting flow of controlled vehicles corresponding to the optimization of multiscale norm, according to another example embodiment of the present disclosure.

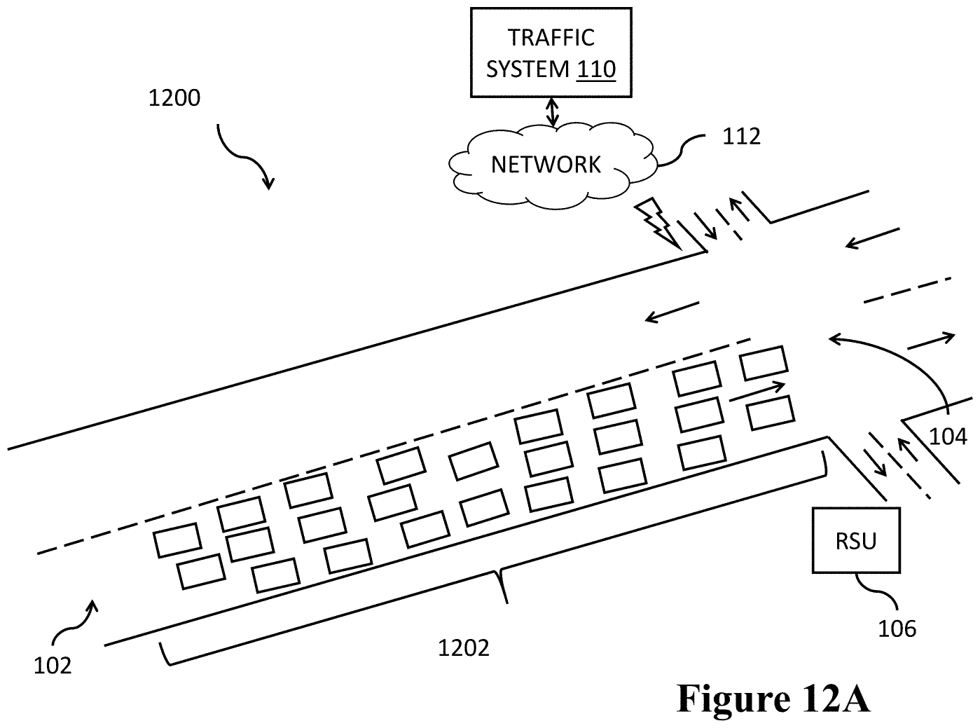

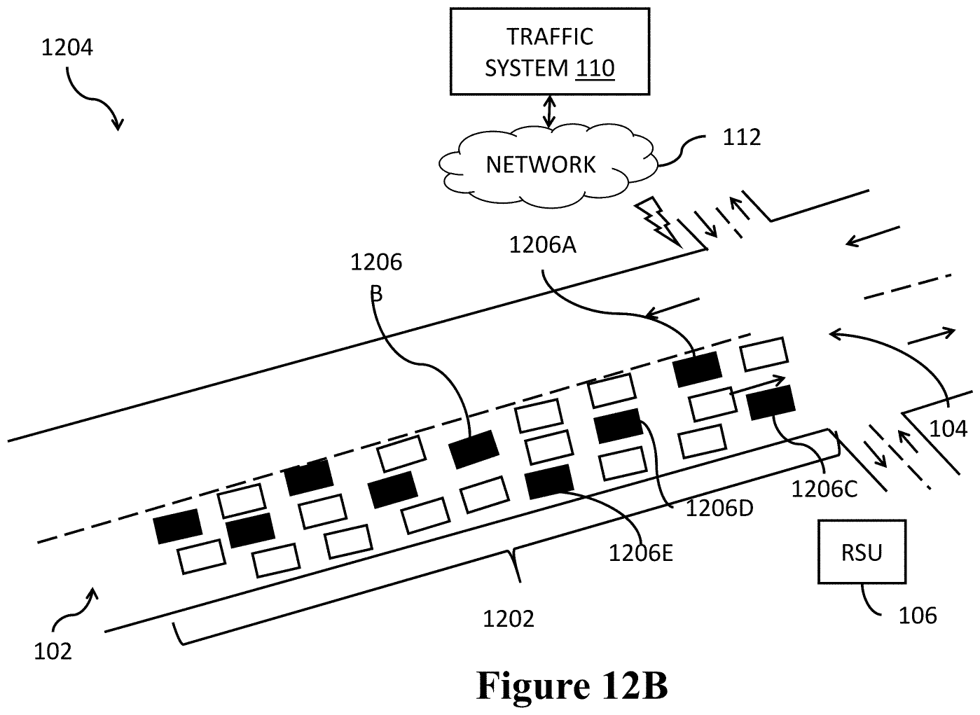

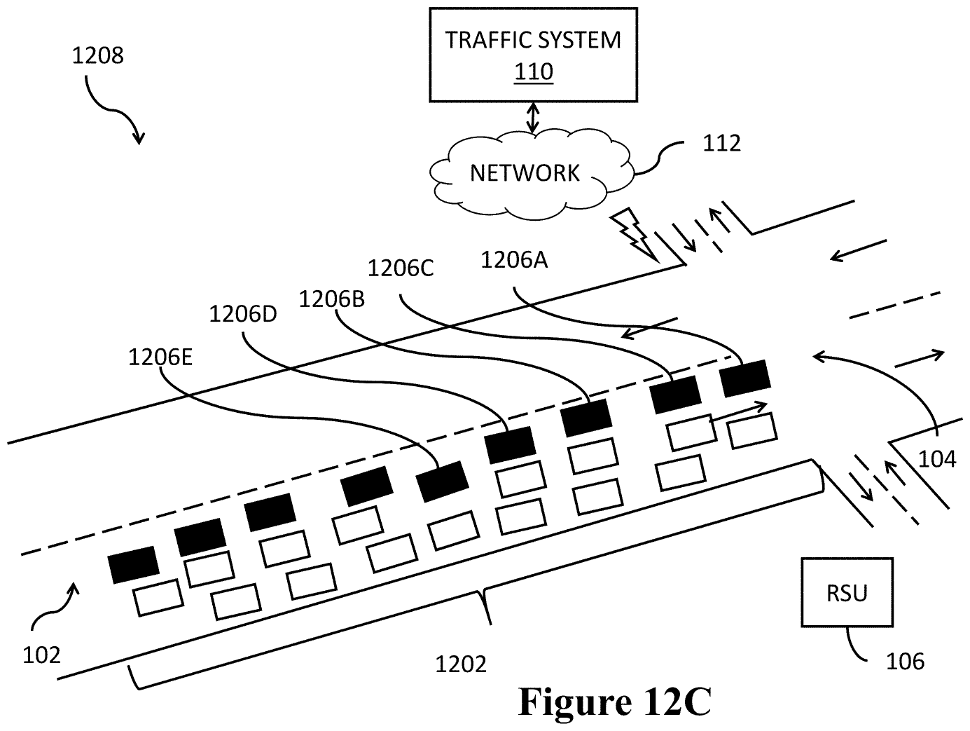

FIG. 12A illustrates a use case scenario of controlling traffic based on the optimization of the multiscale norm, according to one example embodiment of the present disclosure.

FIG. 12B illustrates a scenario of controlling traffic based on the optimization of the multiscale norm, according to another example embodiment of the present disclosure.

FIG. 12C illustrates a scenario of controlling traffic based on the optimization of the multiscale norm, according to another example embodiment of the present disclosure.

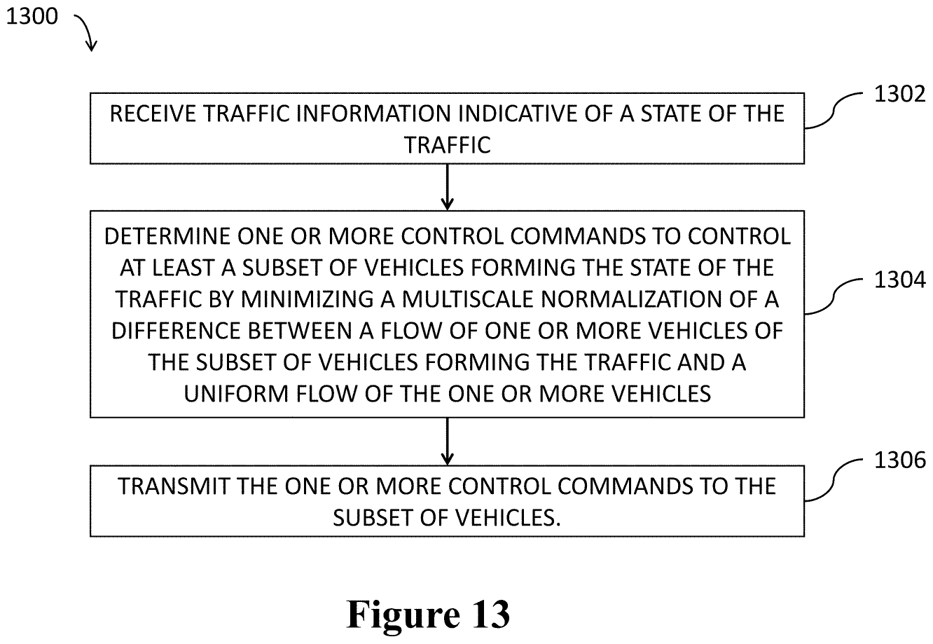

FIG. 13 shows a flow diagram of a method 1300 for traffic control, according to one example embodiment of the present disclosure.

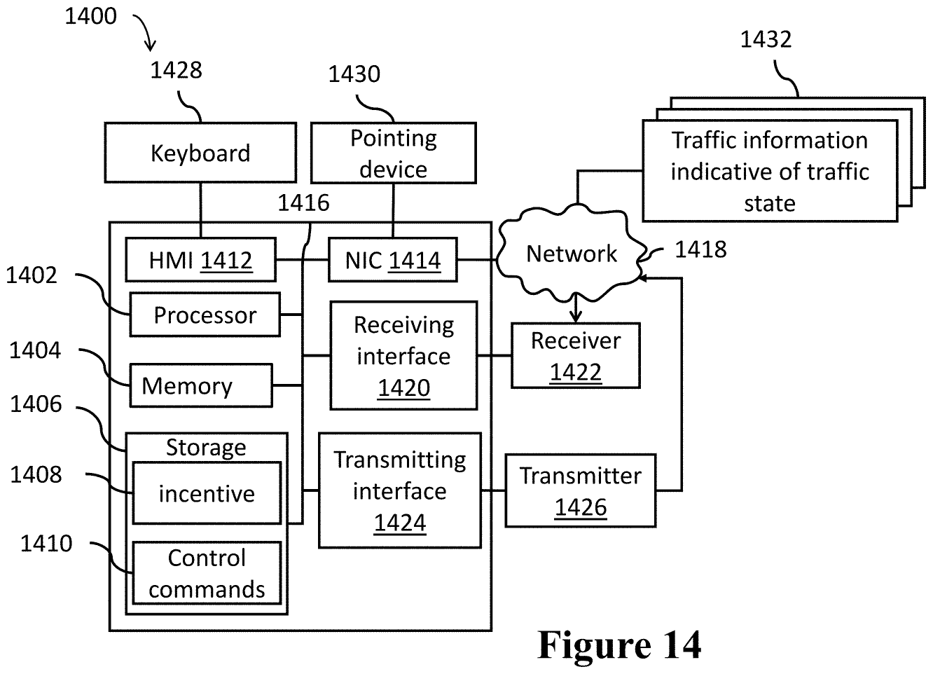

FIG. 14 shows a block diagram of a system for traffic control, according to some embodiments of the present disclosure.

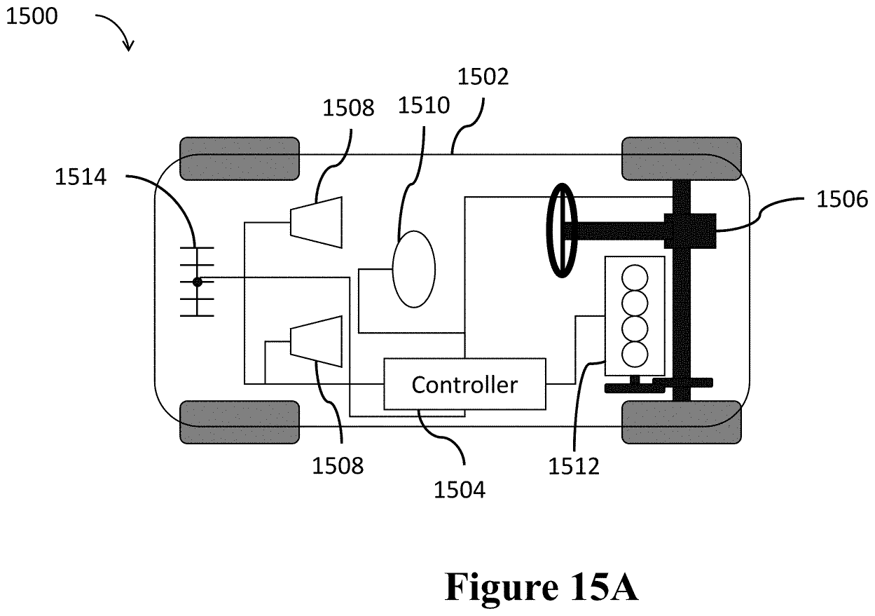

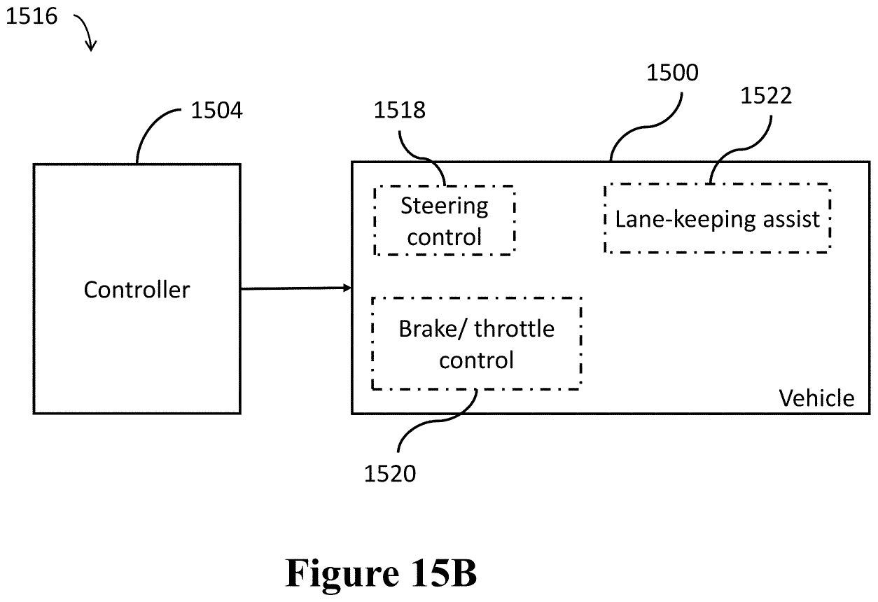

FIG. 15A shows a schematic of a vehicle, according to some embodiments of the present disclosure.

FIG. 15B shows a schematic of interaction between the controller receiving one or more controlled commands from the system and controllers of the vehicle, according to some embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

The present disclosure relates to a vehicular traffic system. These traffic systems generally include roads joined together at junctions, which include interchanges and intersections, motorized and non-motorized vehicles, pedestrians, and traffic signals and signs. Some parts of traffic systems include some or all of these elements.

FIG. 1A illustrates an exemplar of traffic 100 in a road segment 102, according to some embodiments of the present disclosure. In this example, the road segment 102 is a section of a road between two or more junctions (or intersections), such as an intersection 104. Examples of the intersection 104 includes meeting of two or more roads, merging lanes or the like. An edge computing device, such as a road-side unit (RSU) 106 receives traffic information associated with traffic 100 on the road segment 102. Further, the RSU 106 may be connected to other RSUs (not shown in FIG. 1A) that may be installed in other road segments.

In an illustrative example scenario, the traffic 100 in the road segment 102 is formed by vehicles. In the road segment 102, information related to the traffic 100 may be monitored by the road-side unit (RSU) 106. In some other cases, the RSU 106 may include one or more sensors to receive the traffic information from the vehicles. In one example embodiment, the RSU 106 transmits the traffic information to a traffic system 110. The traffic information is indicative of a state of traffic formed by subsets of vehicles. The vehicles forming the traffic on a road 102 may be considered in their entirety or clustered in different subsets to simplify the computation of control commands for each subset. For example, the subsets of vehicles may include a subset of vehicles 108A, a subset of vehicles 108B and a subset of vehicles 108C, as shown in FIG. 1A. The RSU 106 receives information, such as velocity and/or acceleration of the vehicles in each of the subset of vehicles 108A, 108B and 108C.

FIG. 1B shows a graphical plot depicting a model 116 of the traffic 100 in the road segment 102, according to some embodiments of the present disclosure. Some embodiments are based on the realization that vehicle densities are heterogeneous and non-uniform. To that end, the traffic 100 is observed and/or modeled as a flow of the vehicles, which is an equivalent to a non-uniform distribution of the vehicles. The model of the traffic 100 is shown in FIG. 1B.

The model 116 corresponds to a driving behavior of the vehicles. The model 116 is the graphical plot between flow of the vehicles and density of the vehicles. In one example embodiment, flow of the vehicles in the subset of vehicles 108A, 108B and108C may be modeled based on a Lighthill-Whitham-Richards (LWR) model. The LWR model represents behavior of a traffic flow that is assumed to be in an equilibrium state. The flow of each of the subset of vehicles 108A, 108B and 108C may also be represented by other models, such as Payne-Whitham and Aw-Rascle-Zhang (ARZ) models.

In the model 116, a maximum density 118 is a point at which vehicle density of the vehicles is strictly positive and flow is 0, and a maximum speed is initial slope 120 of flow curve 122 plotted against vehicle density. Such combination of the discrete vehicles may model the traffic 100 as a mixed traffic model based on a mean-field optimal control problem. In the mean-field optimal control problem, the vehicles of the subset of vehicles 108A, 108B and 108C are approximated as a flow of infinitesimal rational agents with capabilities to anticipate a traffic situation. In some implementations, the flow of the vehicles of the subset of vehicles 108A, 108B and 108C is used to model traffic on a macroscopic level and the methods described herein improve the traffic 100 based on an optimal control of the vehicles.

Some embodiments are based on realization that flow of the traffic 100 may be treated as fluid that may be regulated using fluid dynamic based technique. Dynamic control of the traffic 100 aims to improve the flow of traffic by controlling flow to be as smooth as possible. This is because uniformity is related to homogeneity. In some embodiments, lesser density of vehicles (i.e. lower frequency) is penalized more than higher density of vehicles (i.e. higher frequency) to achieve homogeneity. In such scenarios, the traffic 100 may be modeled as a fluid, or flow, and absence of traffic may be modeled as another fluid. An equivalent mix of these two fluids achieves a uniform flow of both types of fluids, which is shown in FIG. 1C.

FIG. 1C shows a schematic diagram 124 of mixing fluid 126 and fluid 128 depicting a model for controlling the traffic 100, according to some example embodiments of the present disclosure. In an example embodiment, the fluid 126 corresponds to presence of vehicles, such as the subset of vehicles 108A, 108B and 108C in the road segment 102 and the fluid 128 corresponds to absence of vehicles in the road segment 102. The two fluids 118 and 120 are mixed to form a mixed fluid 130. The mixed fluid 130 is an equivalent mix that achieves a uniform flow of both the fluids 118 and 120.

Naturally, the vehicles are not fluids and the particles representing absence of the vehicles do have dimensions and dynamics different from the particles representing presence of the vehicles. However, after analyzing traffic control problem under mixing based philosophy, some embodiments select mixing technique based on multiscale normalization advantageous for achieving uniformity of distribution in a traffic control. To use such a technique, in some embodiments, a processor of RSU 106 is configured to determine one or more control commands to control at least a subset of vehicles forming the state of the traffic by minimizing a multiscale normalization of a difference between a flow of vehicles forming the traffic and a uniform flow of the vehicles.

In one embodiment, the RSU 106 controls the traffic 100. In some other embodiments, the RSU 106 is connected to a system, such as a traffic system 110 via a network 112. The traffic system 110 determines one or more control commands that are transmitted via a transmitter, such as the RSU 106 to control the one or more vehicles of the subset of vehicles 108A, 108B and 108C, which is described next in FIGS. 2A and 2B.

FIG. 2A shows a block diagram 200 of the traffic system 110 for controlling the traffic 100, according to some embodiments of the present disclosure. The traffic system 110 comprises a receiver 202, a processor 204 and a transmitter 206. The receiver 202 is configured to receive traffic information indicative of a state of the traffic 100. In some embodiments, the traffic system 110 receives the traffic information from the RSU 106. The state of the traffic is formed by the subset of vehicles 108A, 108B and 108C. The processor 204 is configured to determine one or more control commands to control at least the subset of vehicles 108A, 108B and/or 108C. In some embodiments, the one or more control commands are determined by minimizing a multiscale normalization of a difference between a flow of one or more vehicles of the subset of vehicles 108A, 108B and/or 108C forming the traffic and a uniform flow of the one or more vehicles. The transmitter 206 is configured to transmit the one or more control commands to the subset of vehicles 108A, 108B and 108C.

FIG. 2B shows a sequence flow diagram of a method 208 for controlling the traffic 100 in the road segment 102, according to some embodiments of the present disclosure. The method 208 includes a set of instructions executed by a control system (such as the traffic system 110) to control the traffic 100.

At operation 210, the traffic system 110 receives traffic information indicative of a state of the traffic 100 accumulated by the RSU 106. The traffic system 110 processes the traffic information for the traffic control. The traffic state corresponds to vehicle density formed by the subset of vehicles108A, 108B and 108C. In some other embodiments, the RSU 106 may process the traffic information for the traffic control.

At operation 212, the traffic system 110 determines one or more control commands for the one or more vehicles of each of the set of vehicles 108A, 108B and 108C using the traffic information. The one or more control commands include instructions for the vehicles in each of the set of vehicles 108A, 108B or 108C. The instructions may include instruction to reduce or increase acceleration and/or velocity of the one or more controlled vehicles and/or the like.

At operation 214, the traffic system 110 transmits the one or more control commands to the RSU 106. At operation 216, the RSU 106 further transmits the one or more control commands to the one or more vehicles of the subset of vehicles 108A, 108B and 108C.

In some embodiments, the subset of vehicles 108A, 108B and 108C corresponds to one or more of autonomous vehicles. In such cases, a subset of vehicles is selected for controlling the traffic. Additionally, or alternatively, the selected subset of autonomous vehicles is updated periodically based on a predetermined time-period (e.g. 8 minutes). Till the pre-determined time-period is reached, operations 210, 212, 214 and 216 are repeated.

At operation 218, the traffic system 110 periodically updates the subset of vehicles based on a predetermined time-period. At operation 220, the traffic system 110 transmits the one or more control commands for one or more vehicles (i.e. autonomous vehicles) of the updated subset of vehicles 108B to the RSU 106. At operation 222, the RSU 106 transmits the one or more control commands to the subset of vehicles 108B. In a similar manner, the traffic system 110 transmits the one or more control commands for subset of vehicles 108C upon the periodic update.

Additionally, or alternatively, flow of the controlled vehicles may be directly controlled based on a receding horizon approach. In the receding horizon approach, the one or more control commands are updated after a predetermined time-period, which is described next in FIG. 2C.

FIG. 2C shows a sequence flow diagram of a method 224 for controlling the traffic 100 in the road segment 102, according to some other embodiments of the present disclosure. The method 224 includes a set of instructions executed by the traffic system 110 to control the traffic 100. In some example embodiments, the set of instructions are executed by the processor 204 of the traffic system 110.

At operation 226, the traffic system 110 receives the state of the traffic from the RSU 106. At operation 228, the traffic system 110 determines one or more control commands for the one or more vehicles of the subset of vehicles 108A, 108B and 108C. At operation 230, the traffic system 110 transmits the control commands to the RSU 106. At operation 232, the RSU 106 transmits the control commands to the subset of vehicles 108A, 108B and/or 108C.

In some example embodiments, the processor 204 is configured to update the one or more control commands after a predetermined time-period based on the receding horizon approach. In the receding horizon approach, a sequence of control inputs may be used to control the autonomous vehicles. Additionally, or alternatively, a control history may be used to update the control input to the controlled vehicles until it is overridden with a newly computed sequence. The sequence may be determined periodically at regular or irregular intervals.

At operation 234, the traffic system 110 updates the one or more control commands after the predetermined time-period, such as 8 mins, based on the receding horizon approach. At operation 236, the updated control commands are transmitted to the RSU 106. Further, at operation 238, the RSU 106 transmits the updated one or more control commands to the subset of vehicles 108A, 108B and/or 108C.

Some embodiments are based on the understanding that the traffic may be stabilized into a uniform distribution based on a distance-based L2 normalization. The cost and optimization of the L2 normalization is explained next with reference to FIGS. 3A and 3B, respectively.

FIG. 3A shows a graphical plot depicting a cost of L2 norm cost 300 on vehicle density in the traffic 100, according to some embodiments of the present disclosure. The L2 norm cost 300 is plotted between L2 norm cost and time taken for the normalization. In some embodiments, the subset of controlled vehicles in each of the set of vehicles 108A, 108B and 108C are operated based on principles that differ from principles that govern driving of the uncontrolled vehicles. To that end, flow of the subset of vehicles 108A, 108B and108C represented as m=ρv may be provided as a control input to one or more vehicles of the subset of vehicles 108A, 108B and108C. Here, ρ is vehicle density of the subset of vehicles 108A, 108B and108C and v is velocity of the set of vehicles 108A, 108B and 108C. The flow m may be determined by the traffic system 110.

Some embodiments are based on realization that a total vehicle density includes the density of the controlled vehicles and density of the uncontrolled vehicles. The density of the controlled vehicles is used to control the total vehicle density by achieving a uniform distribution of the set of vehicles 108A, 108B and 108C. Such vehicular dynamics of the subset of vehicles (i.e. the subset of controlled vehicles in each of the set of vehicles 108A, 108B and 108C) is given by:

∂ₜ_{^{ρ}}₂+∇m₂=0 (1)

where ρ₂=ρ₂(x, t) is the density of the controlled vehicles of the set of vehicles 108A, 108B and 108C at point x and time t and m₂=m₂(x, t) is the flow of the controlled vehicles of the set of vehicles 108A, 108B and 108C at the point x and time t. The dynamics of the uncontrolled vehicles is therefore given by:

∂ₜ_{^{ρ}}₁+∇(ρ₁v₁(ρ₁+ρ₂))=0 (2)

ρ₁ is the density of the uncontrolled vehicles and v₁ is velocity of uncontrolled vehicles and is given according to a Lighthill-Whitham-Richards (LWR) model:

v₁(ρ)=u₀(1−ρ/ρ*) (3)

so that total velocity is given by ρ=ρ₁+ρ₂. The LWR model represents behavior of a traffic flow that is assumed to be in an equilibrium state.

The object of the control is to achieve a uniform total density of vehicles in the set of vehicles 108A, 108B and 108C. The uniform density implies a uniform flow of traffic, according to the LWR model. A uniform flow is desired due to predictable and laminar nature.

In engineering approaches, optimization techniques may be used to attain a desired goal. In the context of vehicle densities, this optimization approach results in penalizing densities over entire domain, i.e., the road segment 102, so that any deviation from a uniform distribution would cause a deviation from an optimal point, implying that the uniform distribution is optimal. The conventional approach suggests an objective function of the form:

∫∫ρ₂v₂²dxdt+c∫∫(ρ₁+ρ₂)²dxdt (4)
where double integral signifies integration over space and time,
v₂=m₂/ρ₂ is the controlled vehicle velocity and
c is a relative weight between penalty on control and a penalty on vehicle densities ρ₁ and ρ₂.

The L2 norm cost 300 calculates a square root of a sum of squared vector values represented by (ρ₁+ρ₂)² which is a square penalty on the total vehicle density. The square penalty may be a choice of penalty, often used to penalize a deviation. In the context of the control of density, i.e., a type of infinite-dimensional control, the integral of the square penalty is referred to as an L2 cost. The L2 cost penalizes distance to a uniform density of the set of vehicles 108A, 108B and 108C. The vector values correspond to the traffic state formed by the subset of controlled vehicles of the set of vehicles 108A, 108B and 108C. As shown in FIG. 3A, a curve 302 deviates from a distribution curve 304. The deviated curve 302 needs to be optimized, which is described further with reference to FIG. 3B.

FIG. 3B shows a graphical plot depicting optimization 306 of the L2 norm cost 300, according to some embodiments of the present disclosure. The L2 norm cost 300 is minimized based on minimization of equation (3) subject to the dynamics (1) and (2) and the constraints: ρ₁(x, t), ρ₂(x, t), m₂(x, t)≥0 which are positivity constraints for density of the uncontrolled vehicle (ρ₁) and density of the controlled vehicles (ρ₂); and ρ₁(x, t)+ρ₂(x, t)≤ρ* which are capacity constraints for the densities of the uncontrolled vehicles and the controlled vehicles. The objective function is discretized in space and time so that all continuous trajectories become matrices:

ρ₁(xₖ, tᵢ)=ρ_{1,k,i} (5)

In the optimization 306, the L2 norm cost 300 is minimized such that the L2 norm cost 300 asymptotically decreases to an optimal point. As shown in FIG. 3B, curve 308 indicates initial density of the set of vehicles 108A, 108B and 108C at beginning of optimization 306 and curve 310 indicates final density of vehicles at the end of the optimization 306, which is not uniform. Further running the optimization 306 for a longer period of time results in qualitatively same kind of response, i.e., no uniform density.

According to numerical experiments, performing the optimization according to the L2 norm cost has a major drawback. For instance, time taken for the vehicle density to achieve an optimum, i.e. a uniform distribution may be long, which is undesirable. The L2 norm does not sufficiently penalize lower density of the vehicles (i.e. low frequency) relative to high density of the vehicles (high frequency). However, the L2 norm penalizes low and high frequencies equally. The discrete version of the L2 norm in terms of Fourier coefficients is represented as:

∥x∥₂=Σxₖ²+Σ\hat{x}ₖ² (6)

where xₖ is the k-th element of x and \hat{x}ₖ is the k-th Fourier coefficient of x.

However, L2 norm cost optimization (e.g. the optimization 306) fails to achieve an accurate uniform distribution in some scenarios, such as a circular road scenario. To that end, a multiscale normalization approach is implemented for penalizing uniformity, which is further described with reference to FIG. 4A.

FIG. 4A shows a graphical plot depicting cost of a multiscale norm 400 on the vehicle density in the traffic 100, according to some embodiments of the present disclosure. The multiscale norm 400 is plotted between multiscale norm cost and time taken for the normalization. The multiscale norm 400 provides a function:

∫∫ρ₂v₂²dxdt+c(∫∫|(−Δ)^{1/2}(ρ₁+ρ₂)|²dxdt−ρ̅T̅) (7)

where ρ̅ and T̅ are total vehicle density and time taken to achieve the uniform distribution, respectively.

In terms of Fourier coefficients the multiscale norm term is understood as:

∫|(−Δ)^{1/2}ρ|²dx−ρ̅ (8)

Where a vehicle density ρ is discretized, such that ρ=(ρ₀, ρ₁, . . . ), then the multiscale norm 400 becomes:

$${‖ ρ ‖}_{M} = {\sum }_{k = 2}^{∞} \frac{{\hat{p}}_{k}^{2}}{{k}^{2}} \qquad ( 9 )$$

where \hat{ρ}ₖ represents the k-th Fourier coefficient, showing that higher frequencies are penalized less than lower frequencies at a quadratic rate of decrease. Further, \hat{ρ}₁=ρ̅, so that term is omitted from the summation.

As shown in FIG. 4A, curve 402 represents cost of the multiscale norm 400 that needs to be minimized to an optimal point.

FIG. 4B shows a graphical plot depicting optimization 404 of the multiscale norm 400, according to some embodiments of the present disclosure. At the beginning of the optimization 404, initial density of vehicles is indicated by curve 406 and final density of vehicles at the end of the optimization 404 is indicated by curve 408. The curve 408 indicates that final density is almost uniform, as desired.

In some cases, a few occupants (i.e. passengers or operators) of the controlled vehicles in each of the subset of vehicles of the set of vehicles 108A, 108B and 108C may not participate in improving traffic to a uniform flow. In such cases, the controlled vehicles are incentivized to participate in the traffic improvement. The optimization approach may be modified to take into account incentivization by adding an additional constraint. Suppose that distribution of the incentive over x is given by β(x) and the total amount of money available to the RSU 106 is β₀. The additional constraint on allocation of the incentives is given by:

∫β(x)ρ_{2,0}(x)dx≤β₀ (10)

where ρ_{2,0} is initial distribution of density of the controlled vehicles, i.e., ρ₂(x, 0)=ρ_{2,0}(x).

The distribution of incentivized controlled vehicles may be updated periodically based on a pre-determined time-period which determines the frequency at which the optimization is performed. In some embodiments, lower frequency of Fourier mode (i.e. equation (7)) is penalized more than higher frequency of a difference between flows of one or more vehicles of the subset of vehicles of each of the set of vehicles 108A, 108B and 108C, which is described further with reference to FIG. 5.

FIG. 5 shows a multiscale normalization penalizing a lower-frequency Fourier mode of the difference greater than a higher-frequency Fourier mode, according to one example embodiment of the present disclosure. It is well known that any integrable signal can be decomposed into an infinite sum of sinusoidal signals according to,

$$f ( x ) = {\sum }_{k = - ∞}^{∞} {\hat{f}}_{k} {e}^{i 2π ( \frac{k}{T} ) x}$$

where \hat{f}ₖ represents the k-th Fourier coefficient. A multiscale norm is any norm that penalizes higher-frequency Fourier coefficient more than lower-frequency Fourier coefficients, i.e., modes corresponding to a coefficient with lower absolute value of k are penalized more than modes with a coefficient with higher absolute value of k. This results in a downward trend 503 when plotting penalty against coefficient in FIG. 5. For comparison, the L2 norm penalizes all Fourier modes equally 502. In some embodiments, the processor 204 is configured to determine a penalty on distribution of the one or more vehicles of the subset of vehicles 108A, 108B and 108C and a penalty on acceleration of the one or more vehicles of the subset of vehicles 108A, 108B and 108C based on the penalty on the lower-frequency Fourier mode.

FIG. 6 shows a block diagram for determining an amount of incentive for each of the subset of vehicles 108A, 108B and 108C based on the minimized multiscale normalization, according to one example embodiment of the present disclosure.

In some example embodiments, a total amount available for incentivization may be fixed 606 and an offer may be made for one time over a time-period [0, T] 612.

In some example embodiments, numerical simulations are performed to test and exhibit properties of optimization of the multiscale normalization, which is explained further.

FIG. 7 shows a table 700 of parameter 702 for a test simulation of traffic control of the subset of vehicles, according to one example embodiment of the present disclosure. The parameter 702 include spatial domain measured in miles (mi), time-period (T) measured in minutes (min), initial velocity of the vehicles (u₀) measured in miles per minute (mi/min), density ρ* measured in vehicles per minute (vehicle/min) and a constant c for penalizing differences in vehicle densities. The table 700 includes a column for unit 706 that stores measurement unit of the parameter 702. In all simulations, the parameter 702 is set to value 704 given in the table 700 and the optimization problem is solved using a software package, such as cvx. In some embodiments, the optimization problem is solved in a two-step iterative approach. In first step, density of the uncontrolled vehicles is fixed in space and time and an optimal control and density of controlled vehicles is determined based on Lax-Friedrichs discretization. In next step, dynamics of the uncontrolled vehicles is propagated using a first-order Godunov scheme to determine a new value for density of the uncontrolled vehicles, using the density of the controlled vehicles obtained in the first step.

The parameter 702 and value 704 in the table 700 are used for running one or more test simulations for controlling the traffic 100. The results of such simulations are shown in FIG. 8.

FIG. 8 shows a graphical plot 800 depicting initial distribution of total vehicle density in the test simulation, according to one example embodiment of the present disclosure. An initial distribution of the controlled vehicles, i.e. initial vehicle density (ρ₀) over spatial domain, Ω=S¹ is given by, ρ₀(x)=3.5+2 sin(πx). In FIG. 8, the initial vehicle density is indicated by curve 802 and an average of the vehicle density is indicated by curve 804.

The results of the test simulations depict evolution of the vehicle density without control, i.e., v2=v1(ρ1,ρ2) is shown in FIGS. 9A, 9B and 9C.

### Optimization of L2 Norm Cost

FIG. 9A shows a graphical plot 900 depicting time history of total vehicle density corresponding to optimization of L2 norm cost, such as the L2 norm cost 300, according to one example embodiment of the present disclosure. In the graphical plot 900, total vehicle density at time, t=0 is indicated by curve 902, total vehicle density at time t=T/4 is indicated by curve 904, total vehicle density at time t=T/2 is indicated by 906 and total vehicle density at time t=T is indicated by curve 908. The curves 902-908 are plotted corresponding to the optimization of the L2 norm cost 300 with N=1, where N is a design parameter.

In the first simulation, a control input is determined according to solution of the optimization problem (4) and constraints of equation (5) which penalizes the vehicle density according to the L2 norm cost 300. The incentivization parameter may be set as β=0.2 so that 0.2 subset of controlled vehicles in each of the set of vehicles 108A, 108B and 108C are controlled. The L2 norm cost 300 is optimized over a finite time-horizon. As the time reaches the end of the optimization, a receding horizon approach is implemented.

The optimization of the L2 norm cost 300 is performed at time interval [0,T] and the optimized cost is implemented as the control input over [0,T/N], where N is a design parameter. In the simulation, the design parameter N=1. The optimization problem is solved over the time-interval [T/N,T+T/N] with initial conditions set to the values obtained at time T/N and implement the control over [T/N,2T/N]. This process is repeated for times 2T/N,3T/N, . . . until a solution over the entire time-interval [0,T] is determined. In second simulation, the design parameter N=2 and optimization of the L2 norm cost 300 is performed. Similar curves, i.e. the curves 902-908 are plotted as shown in FIG. 9A. In particular, the density distribution at the final time is very close to the density distribution in the uncontrolled vehicles. Shortening the control horizon by setting N>1 achieves an even worse result; this is shown in FIG. 9B, for which we set N=2.

FIG. 9B shows a graphical plot 910 depicting normalized time history of L2 norm cost 300 corresponding to the uncontrolled vehicles, according to one example embodiment of the present disclosure. The graphical plot 910 is obtained based on simulations for N=1, 2, 4, 8, 16. The normalized time history corresponds to density component of the time history of the L2 norm cost 300 represented by:

$$\frac{1}{{3.5}^{2 \vert Ω \vert}} {{f}_{Ω} ( {ρ}_{1} ( x , t ) + {ρ}_{2} ( x , t ) )}^{2} dx \qquad ( 11 )$$

The graphical plot 910 shows that the density component of the L2 norm cost 300 may be initially reduced in all cases. However, this fails to evenly distribute traffic in a steady state. Moreover, performance of the L2 norm cost 300 deteriorates as N>1.

### Optimization of Multiscale Norm

FIG. 10A shows a graphical plot 1000 depicting time history of a total vehicle density corresponding to the optimization of the multiscale norm 400, according to one example embodiment of the present disclosure. In the graphical plot 1000, total vehicle density at time, t=0 is indicated by curve 1002, total vehicle density at time t=T/4 is indicated by curve 1004, total vehicle density at time t=T/2 is indicated by 1006 and total vehicle density at time t=T is indicated by curve 1008. The curves 1002-1008 are plotted corresponding to the optimization of the L2 norm cost 300 with N=1, where N is a design parameter. In the first simulation, a control input is determined according to the solution of the optimization problem (equation 7) and constraint (equation 10), which penalizes density according to the multiscale norm 400. In the simulation, the incentivization parameter β=0.2 and N=1. The graphical plot 1000 shows that the total vehicle density reaches close-to-uniform distribution at time T/2 (i.e. curve 1008). However, by the end of the simulation, the curve 1006 drifts away from uniformity. The curve 1008 drifts from the uniformity due to a finite time-horizon, and so do not sufficiently penalize steady state. In further simulations, the curve 1008 converges to uniformity when N=2, which is shown in FIG. 10B.

FIG. 10B shows a graphical plot 1010 depicting time history of the total vehicle density corresponding to the optimization of the multiscale norm 400, according to another example embodiment of the present disclosure. In the graphical plot 1010, the curve 1008 converges with curve 1006 to uniform curve 1012.

After obtaining numerical results from the simulation, densities for the uncontrolled vehicles and the controlled vehicles of the set of vehicles 108A, 108B and 108C are controlled, which are shown in FIG. 11.

FIG. 11 shows a graphical plot 1100 depicting flow of the controlled vehicles corresponding to the optimization of the multiscale norm 400, according to another example embodiment of the present disclosure. The graphical plot 1100 shows that the density of the uncontrolled vehicles at t=0 is represented by curve 1102, the density of the uncontrolled vehicles at time t=T/4 is represented by curve 1104, the density of the uncontrolled vehicles at time t=T/2 is represented by 1106 and the density of the uncontrolled vehicles at time t=T is represented by curve 1108. The graphical plot 1100 shows that the optimal approach is to select an incentive parameter of 0.2 for the subset of vehicles and switch the selected vehicles into cooperative mode and re-compute the distribution again halfway through the time-period [0,T]. The graphical plot 110 shows that required flow to obtain the desired result is high. For instance, the controlled vehicles are required to drive at maximum rate in four separate lanes. In some scenarios, the graphical plot 1100 is utilized to suggest operations to the controlled vehicles, such as suggestion of use of at least one dedicated lane for the controlled vehicles in order to implement the scheme along with a limit on the flow of the controlled vehicles. When a desired flow rate for controlled vehicles is not possible to achieve for the controlled vehicles in one lane, controlled vehicles are redirected to another, possibly dedicated, lane to achieve the desired flow rate. In an additional simulation, the limit at the maximum rate according to the LWR model is set, which corresponds to the use of at most one additional dedicated lane of the controlled vehicles.

$$\frac{{u}_{0} {p}^{*}}{4} = 2.5$$

### Exemplar Embodiments

FIG. 12A illustrates a scenario 1200 of controlling traffic based on the multiscale normalization, according to one example embodiment of the present disclosure. The vehicles of the subset of vehicles 108A, 108B and108C are uniformly distributed to achieve a uniform traffic state 1202, as shown in FIG. 12A. The traffic system 110 determines one or more control commands for the subset of vehicles 108A, 108B and 108C forming the state of the traffic by minimizing a multiscale normalization of a difference between a flow of one or more vehicles of the subset of vehicles forming the traffic and a uniform flow of the one or more vehicles.

In some embodiments, some vehicles of the subset of vehicles 108A, 108B and 108C are incentivized to change from uncooperative to cooperative mode based on the multiscale normalization. The cooperative may correspond to autonomous or controlled vehicles. The incentivization allows the traffic system 110 to stabilize the traffic 100, as shown in FIG. 12B.

FIG. 12B illustrates a scenario 1204 of controlling traffic based on the multiscale normalization, according to another example embodiment of the present disclosure. The traffic system 110 also determines an amount of incentive for the subset of vehicles to cooperate in achieving a uniform distribution of vehicles in the road segment 102 and improve traffic. For instance, the one or more control commands and the amount of incentive are determined for controlled vehicles, such as controlled vehicles 1206A-1206E. The one or more control commands and the incentive amount are transmitted to the controlled vehicles 1206A-1206E via the RSU 106. The incentivization enables the traffic system 110 to control a portion of vehicles, vehicles 1206A-1206E in the road segment 102. This allows the traffic system 110 to operate efficiently in controlling the traffic. Additionally, or alternatively, operators of the vehicles 1206A-1206E may be given a choice to let their vehicle participate in the traffic control based on the incentivization.

In some embodiments, the controlled vehicles of the subset of vehicles 108A, 108B and 108C may be suggested to use a dedicated lane for stabilizing the traffic, as shown in FIG. 12C.

FIG. 12C illustrates a scenario 1208 of controlling traffic based on the multiscale normalization, according to another example embodiment of the present disclosure. In an illustrative scenario, the controlled vehicles, such as the vehicles 1206A-1206E are controlled by the traffic system 110 to travel in a dedicated lane for stabilizing the traffic. The traffic system 110 transmits the control commands for the traffic control to the vehicles 1206A-1206E, via the RSU 106.

FIG. 13 shows a flow diagram of a method 1300 for traffic control, according to one example embodiment of the present disclosure. The method 1300 uses a processor, such as the processor 204 coupled with stored instructions implementing the method 1300. The instructions, when executed by the processor 204 carry out steps of the method 1300.

At step 1302, traffic information indicative of a state of the traffic is received. The traffic information may be accumulated by an RSU, such as the RSU 106 (refer FIG. 2B).

At step 1304, one or more control commands is determined to control at least a subset of vehicles, such as the subset of vehicles 108A, 108B and 108C forming the state of the traffic, by minimizing a multiscale normalization of a difference between a flow of one or more vehicles of the subset of vehicles 108A, 108B and 108C forming the traffic and a uniform flow of the one or more vehicles. The uniform flow of the one or more vehicles may be obtained by treating the subset of vehicles 108A, 108B, and 108C as fluid and further, the fluids are mixed together which may result into a uniform flow of the one or more vehicles of the subset of vehicles 108A, 108B, and 108C.

At step 1306, the one or more control commands are transmitted to the subset of vehicles 108A, 108B and 108C.

FIG. 14 shows a block diagram of a system 1400 for traffic control, according to some embodiments of the present disclosure. The system 1400 corresponds to the traffic system 110. The system 1400 includes a receiver 1420 that receives traffic information indicative of a state of traffic. The traffic information 1130 may include information of a current state of a flow of the traffic in a road segment (e.g. the road segment 102), an inflow rate of the traffic into the road segment 102, or the like. The current traffic may also include information about current locations and target locations of the controlled vehicles. The target locations of the uncontrolled vehicles are usually unknown. The receiver 1420 provides the traffic information 1432 to via a receiving interface 1420 of the system 1400. In some embodiments, the system 1400 receives the traffic information 1430 via a network 1418. The system 1100 is connected to the network 1418 via a network interface controller 1414. The system 1400 also includes a processor 1402 and a memory 1404 storing instructions to be executed by the processor 1402. The processor 1402 may be a single core processor, a multi-core processor, a computing cluster, or any number of other configurations. The processor 1402 may include multiple processors operatively connected to achieve common objectives. The processor 1402 is connected through a bus 1416 to one or more input devices, such as keyboard 1428 and a pointing device 1430. The memory 1104 may include random access memory (RAM), read only memory (ROM), flash memory, or any other suitable memory systems.

The processor 1402 is configured to determine one or more control commands 1410 to control at least a subset of vehicles forming the state of the traffic by minimizing a multiscale normalization (e.g. the multiscale norm 400) of a difference between a flow of one or more vehicles of the subset of vehicles (e.g. the subset of controlled vehicles of the set of vehicles 108A, 108B and 108C) forming the traffic and a uniform flow of the one or more vehicles as described in description with respect to FIGS. 12A and 12B. In one example embodiment, the processor 1402 is further configured to select the subset of vehicles, i.e. the one or more controlled vehicles of the set of vehicles 108A, 108B and 108C. The selected subset of vehicles is periodically updated based on a predetermined time-period.

The one or more control commands 1410 are transmitted to a transmitter 1426 via a transmitting interface 1424. The transmitter 1426 further transmits the one or more control commands to the one or more vehicles via a network 1418. The network 1418 corresponds to the network 112 of FIG. 1A. The one or more control commands are further transmitted to the one or more vehicles via the RSU 106 using the network 1418. The processor 1402 is also configured to determine a penalty on distribution of the one or more vehicles and a penalty on acceleration of the one or more vehicles based on the penalty on the lower frequency Fourier mode. The processor 1402 is also configured to determine an amount of incentive 1408 for each of the one or more vehicles based on the minimized multiscale normalization. In some embodiments, the amount of incentive and the one or more control commands 1410 are simultaneously determined. Further, information of the amount of incentive 1408 and the one or more control commands 1410 are stored in storage 1406. The processor 1402 is configured to update the one or more control commands 1410 after a predetermined time-period based on a receding horizon control algorithm.

The system 1400 may have a number of interfaces connecting the system 1400 with other machines and devices, such as the RSU 106. For example, a network interface controller 1414 is adapted to connect the RSU 106 through the network 1418. Through the network 1418, the traffic information may be received and downloaded for further processing.

The transmitter 1426 is configured to transmit the one or more control commands to corresponding controlled vehicles to perform direct control of the controlled vehicles. For example, in some embodiments each controlled vehicles has an assigned identification number (ID). The transmitter 1426 broadcasts or unicasts the one or more control commands determined for a specific vehicle using a message including the ID of that specific vehicle. In some embodiments, the transmitter 1426 may execute an indirect control of the uncontrolled vehicles based on the LWR model.

FIG. 15A shows a schematic of a vehicle 1500, according to some embodiments of the present disclosure. As used herein, the vehicle 1500 may be any type of wheeled vehicle, such as a passenger car, bus, or rover. Also, the vehicle 1500 may be an autonomous or semi-autonomous vehicle. For example, some embodiments control the motion of the vehicle 1500. Examples of the motion include lateral motion of the vehicle 1500 controlled by a steering system 1506 of the vehicle 1500. In one embodiment, the steering system 1506 is controlled by the controller 1504 in communication with the system 1400. Additionally, or alternatively, the steering system 1506 may be controlled by a driver of the vehicle 1500.

The vehicle may also include an engine 1512, which may be controlled by the controller 1504 or by other components of the vehicle 1500. The vehicle 1500 may also include one or more sensors 1508 to sense the surrounding environment. Examples of the sensors 1508 include distance range finders, radars, lidars, and cameras. The vehicle 1500 may also include one or more sensors 1510 to sense its current motion quantities and internal status. Examples of the sensors 1510 include global positioning system (GPS), accelerometers, inertial measurement units, gyroscopes, shaft rotational sensors, torque sensors, deflection sensors, pressure sensor, and flow sensors. The sensors (i.e. the sensors 1508 and 1510) provide information to the controller 1504. The vehicle 1500 may be equipped with a transceiver 1514 enabling communication capabilities of the controller 1504 through wired or wireless communication channels.

FIG. 15B shows a schematic 1516 of interaction between the controller 1504 receiving the one or more controlled commands and incentives from the system 1400 and controllers of the vehicle 1500 according to some embodiments. For example, in some embodiments, the controllers of the vehicle 1500 are steering control 1518 and brake/throttle control 1520 that control rotation and acceleration of the vehicle 1500. In such a case, the controller 1504 outputs control inputs to controllers of the vehicle 1500 to control the state of the vehicle 1500. The controllers of the vehicle 1500 may include high-level controllers, e.g., a lane-keeping assist controller 1522 that further process the control inputs of a predictive controller (i.e., the controller 1504). In both cases, the controllers of the vehicle 1500 use the outputs of the predictive controller to control at least one actuator of the vehicle 1500, such as the steering wheel and/or the brakes of the vehicle 1500, in order to control the motion of the vehicle 1500. The states of the vehicular machine may include position, orientation, and longitudinal/lateral velocities; control inputs may include lateral/longitudinal acceleration, steering angles, and engine/brake torques. Control input constraints may include steering angle constraints and acceleration constraints. Collected data could include position, orientation, and velocity profiles, accelerations, torques, and/or steering angles.

The above-described embodiments of the present invention may be implemented in any of numerous ways. For example, the embodiments may be implemented using hardware, software or a combination thereof. When implemented in software, the software code may be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Therefore, it is the object of the appended claims to cover all such variations and modifications as come within the true spirit and scope of the invention.

1. A system for traffic control, comprising:
a receiver configured to receive traffic information indicative of a state of a traffic;
a processor configured to determine one or more control commands to control at least a subset of vehicles forming the state of the traffic by minimizing a multiscale normalization of a difference between a flow of one or more vehicles of the subset of vehicles forming the traffic and a uniform flow of the one or more vehicles; and
a transmitter configured to transmit the one or more control commands to the subset of vehicles.

2. The system of claim 1, wherein the multiscale normalization penalizes a lower-frequency Fourier mode of the difference greater than a higher-frequency Fourier mode.

3. The system of claim 1, wherein the subset of vehicles corresponds to one or more of autonomous vehicles.

4. The system of claim 3, wherein the processor is further configured to periodically update the subset of vehicles based on a predetermined time-period.

5. The system of claim 1, wherein the processor is further configured to determine an amount of incentive for each of the subset of vehicles based on the minimized multiscale normalization.

6. The system of claim 5, wherein the amount of incentive and the one or more control commands are simultaneously determined.

7. The system of claim 2, wherein the processor is further configured to determine a penalty on distribution of the one or more vehicles of the subset of vehicles and a penalty on acceleration of the one or more vehicles of the subset of vehicles based on the penalty on the lower-frequency Fourier mode.

8. The system of claim 1, wherein the processor is further configured to update the one or more control commands after a predetermined time-period based on a receding horizon control algorithm, and wherein the updated one or more control commands are transmitted to the subset of vehicles via the transmitter.

9. The system of claim 3, wherein the processor is further configured to determine control history for the one or more of autonomous vehicles based on flow of the one or more of autonomous vehicles.

10. A method for controlling a traffic, wherein the method uses a processor coupled with stored instructions implementing the method, wherein the instructions, when executed by the processor carry out steps of the method, comprising:
receiving traffic information indicative of a state of the traffic;
determining one or more control commands to control at least a subset of vehicles forming the state of the traffic by minimizing a multiscale normalization of a difference between a flow of one or more vehicles of the subset of vehicles forming the traffic and a uniform flow of the one or more vehicles; and
transmitting the one or more control commands to the subset of vehicles.

11. The method of claim 10, further comprising penalizing a lower-frequency Fourier mode of the difference greater than a higher-frequency Fourier mode based on the minimized multiscale normalization.

12. The method of claim 10, further comprising periodically updating the subset of vehicles based on a predetermined time-period.

13. The method of claim 10, further comprising determining an amount of incentive for the subset of vehicles based on the minimized multiscale normalization.

14. The method of claim 13, wherein the amount of incentive and the one or more control commands are simultaneously determined.

15. The method of claim 11, further comprising determining a penalty on distribution of the one or more vehicles of the subset of vehicles and a penalty on acceleration of the one or more vehicles of the subset of vehicles based on the penalty on the lower-frequency Fourier mode.

16. The method of claim 10, further comprising:
updating the one or more control commands after a pre-determined time-period based on a receding horizon control algorithm; and
transmitting the updated one or more control commands to the subset of vehicles.

17. The method of claim 10, wherein the subset of vehicles corresponds to one or more of autonomous vehicles.

18. The method of claim 17, further comprising determining control history for the one or more of autonomous vehicles based on flow of the one or more of autonomous vehicles.

19. A non-transitory computer readable storage medium embodied thereon a program executable by a processor for performing a method, the method comprising:
receiving traffic information indicative of a state of a traffic;
determining one or more control commands to control at least a subset of vehicles forming the state of the traffic by minimizing a multiscale normalization of a difference between a flow of one or more vehicles of the subset of vehicles forming the traffic and a uniform flow of the one or more vehicles; and
transmitting the one or more control commands to the subset of vehicles.

20. The non-transitory computer readable storage medium of claim 19, wherein the method further comprising penalizing a lower-frequency Fourier mode of the difference greater than a higher-frequency Fourier mode based on the multiscale normalization.
